(19) United States
(12) Patent Application Publication
(10) Pub. No.: US 2008/0125173 A1
(43) Pub. Date: May 29, 2008

(54) MOBILE ELECTRONIC APPARATUS, METHOD, AND COMPUTER READABLE MEDIUM THEREOF FOR DYNAMICALLY ARRANGING THE DISPLAY SEQUENCE OF FUNCTION OPTIONS

(75) Inventor: Te Cheng Chen, Taichung County (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 11/696,587

(22) Filed: Apr. 4, 2007

(30) Foreign Application Priority Data
Nov. 28, 2006 (TW) 095143985

(51) Int. Cl. H04B 1/38

(52) U.S. Cl. 455/557

(57) ABSTRACT

A mobile electronic apparatus, method, and computer readable medium for dynamically arranging the display sequence of a plurality of function options are provided. A sensing module senses a plurality of environment parameters. An input module receives a user's input to choose the function options. A storage module stores information which is updated dynamically according to chosen times of the function options. A processing module arranges the display sequence of the function options according to the environment parameters and the information. Finally, a display module displays the function options according to the display sequence in order to solve the problems of adjusting the display sequence manually and simply according to the chosen times of the prior art.

This application claims the benefit of priority based on Taiwan Patent Application No. 095143985 filed on Nov. 28, 2006 of which the contents are incorporated herein by reference in its entirety.

### CROSS-REFERENCES TO RELATED APPLICATIONS

Not applicable.

### BACKGROUND OF THE INVENTION

1. Field of the Invention

The present invention relates to a mobile electronic apparatus and a method; more particularly, relates to a mobile electronic apparatus, and a method for dynamically arranging a display sequence of function options. The method can be implemented by a computer program which is stored in a computer readable medium.

2. Descriptions of the Related Art

In recent years, techniques of various kinds of electronic products have made great progress so that functions of electronic products become more complicated. These mobile electronic apparatuses, such as a mobile phone, a personal digital assistant, etc., which are portable, can satisfy many users' requests. However, the functions of current mobile electronic apparatuses are too complicated, and each function comprises many sub-options. The function options which are many and complicated not only cause difficulties in operating, but waste too much operating time in choosing the required function option. Besides, searching for the required function option consumes unnecessary electric power of the mobile electronic apparatus.

Since the function options are complicated, most manufacturers of mobile electronic apparatuses are trying to simplify the function options. For example, mobile phones manufactured by Nokia in current market allow users to set different short cuts for different function options and sequences with a short cut menu. However, the approach for simplifying function menus can only allow users to manually set the short cuts instead of simplifying function menus automatically.

Taiwan patent No. 527812 discloses a mobile communication electronic apparatus capable of simplifying function menus automatically. The mobile communication electronic apparatus calculates and records times that a user selects the function options. Then, a function option which is seldom selected is hidden from the function menu to achieve the objective of simplifying the function options in the function menu. However, this approach can only simplify the function menu based on the usage times, and other factors are not considered. For example, the function options being selected depend on the time and the place.

Therefore, except the usage times, how to further consider other factors to simplify and arrange the function options to make mobile electronic apparatuses adequately present the function menu is deeply desired by widespread consumers.

### SUMMARY OF THE INVENTION

One objective of this invention is to provide a mobile electronic apparatus capable of dynamically arranging a display sequence of a plurality of function options. The mobile electronic apparatus comprises a sensing module, an input module, a memory, a processing module, and a display module. The sensing module senses a plurality of environment parameters of the mobile electronic apparatus. The input module is for a user to select one of the function options. The memory stores a plurality of pieces of information, and the pieces of information are updated dynamically according to the selection. The processing module arranges the display sequence according to the environment parameters and the pieces of information. The display module displays the function options in the display sequence.

Another objective of this invention is to provide a method for dynamically arranging a display sequence of a plurality of function options. The method comprises the following steps: storing a plurality of pieces of information; sensing a plurality of environment parameters; selecting one of the function options; updating the pieces of information dynamically according to the selection of the selecting step; arranging the display sequence according to the environment parameters and the pieces of information; and displaying the function options in the display sequence.

Yet a further objective of this invention is to provide a computer readable medium storing a computer program for a mobile electronic apparatus to execute a method for dynamically arranging a display sequence of a plurality of function options. The method comprises the following steps: storing a plurality of pieces of information; sensing a plurality of environment parameters; selecting one of the function options; updating the pieces of information dynamically according to the selection of the selecting step; arranging the display sequence according to the environment parameters and the pieces of information; and displaying the function options in the display sequence.

The present invention can arrange and display the function options by sensing where the mobile electronic apparatus locates and recording times that the user selects one of the function options. Furthermore, habits of the user and various situations are considered for calculating and arranging a sequence of the function options. Therefore, the drawback of manually arranging a sequence of the function options or arranging a sequence only depending on the usage times can be solved. Besides, because the function options are arranged in a sequence according to the selected times by users under different environments, most frequently used function options under different environments can be easily selected first from the mobile electronic apparatus by users.

The detailed technology and preferred embodiments implemented for the subject invention are described in the following paragraphs accompanying the appended drawings for people skilled in the art to well appreciate the features of the claimed invention.

### BRIEF DESCRIPTION OF THE DRAWINGS

FIG. 1 is a schematic diagram illustrating a first embodiment of the present invention;

FIG. 2 is a table illustrating the pieces of information stored in the memory of the first embodiment;

FIG. 3 is another table illustrating the pieces of information stored in the memory of the first embodiment;

FIG. 4 is a menu generated by a display module of the first embodiment;

FIG. 5 is another menu generated by the display module of the first embodiment; and

FIG. 6 is a flow chart of a second embodiment and a third embodiment of the present invention.

### DESCRIPTION OF THE PREFERRED EMBODIMENT

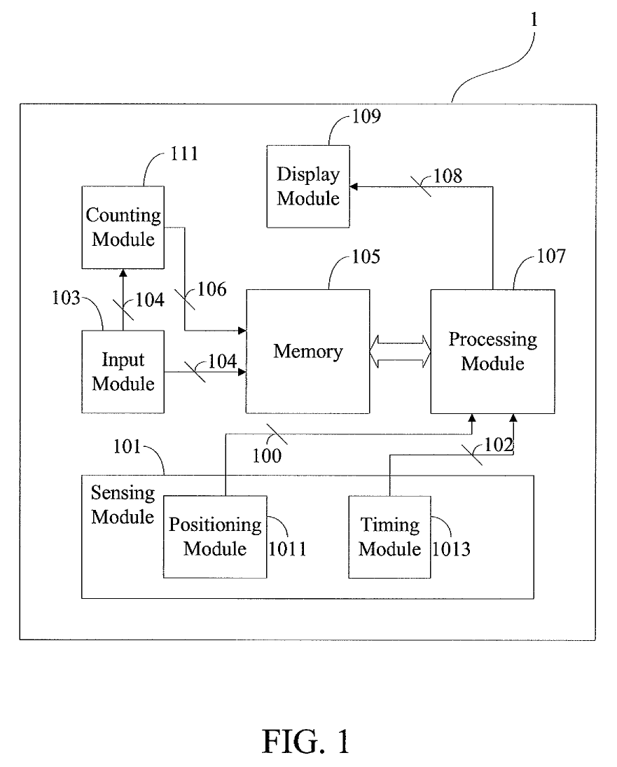

As shown in FIG. 1, a first embodiment of the present invention is a mobile electronic apparatus 1 capable of dynamically arranging a display sequence of a plurality of function options. The mobile electronic apparatus 1 can be a mobile phone or a personal digital assistant (PDA) in current market. The mobile electronic apparatus 1 comprises a sensing module 101, an input module 103, a memory 105, a processing module 107, a display module 109, and a counting module 111. The sensing module 101 further comprises a positioning module 1011 and a timing module 1013.

The sensing module 101 respectively senses an environment where the mobile electronic apparatus 1 locates by the positioning module 1011 and sense the time the user select one function option by the timing module 1013. More specifically, the positioning module 1011 positions a location of the mobile electronic apparatus 1, and generates a location parameter 100 according to the location of the mobile electronic apparatus 1. The positioning module 1011 can be a positioning device using currently mature navigation technique, such as Global Positioning System (GPS), Global Navigation Satellite System (GLONASS), or Galileo Positioning System (GPS). The timing module 1013 can be any clock device for measuring time. For example, a clock built in the mobile electronic apparatus 1 can be a source to generate a time parameter 102.

The present invention does not limit numbers and types of the environment parameters. The location parameter and the time parameter mentioned in the first embodiment are only two kinds of the environment parameters. Those skilled in the art can implement the present invention by using any type or any number of the environment parameters.

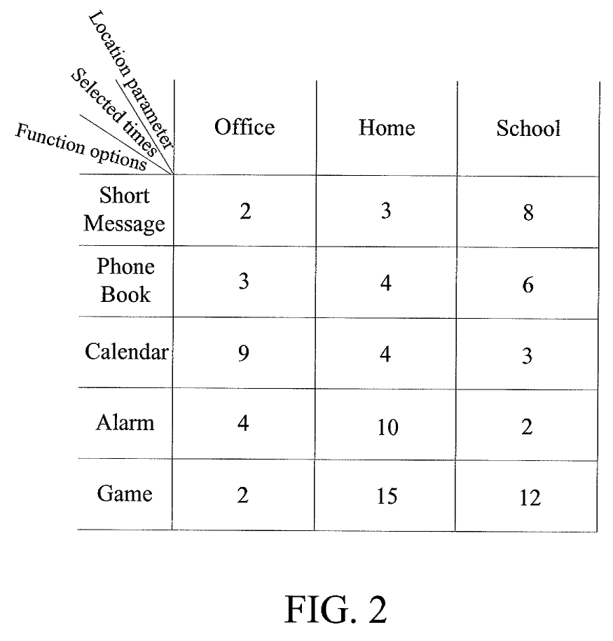

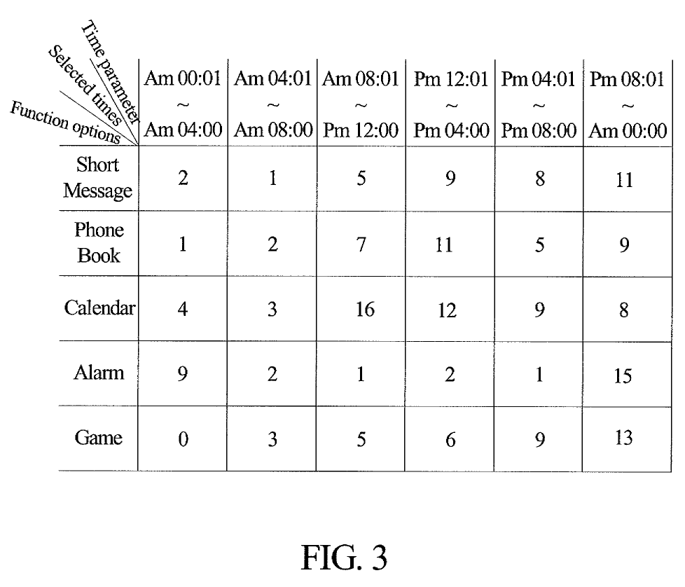

The input module 103 allows users selecting the function options available in the mobile electronic apparatus 1. The memory 105 stores a plurality of pieces of information which record the usage times of the function options selected by the user at a certain time and place. As shown in FIG. 2 and FIG. 3, the pieces of information regarding place and time are recorded as the two tables which is stored in the memory 105. The memory 105 gets the location parameter 100 and the time parameter 102 via the processing module 107 to update usage times of the function options selected by the user in response to the location parameter 100 and the time parameter 102.

When the user selects one of the function options of the mobile electronic apparatus 1 via the input module 103, the mobile electronic apparatus 1 will update the pieces of information stored in the memory 105 according to the environment parameters sensed by the sensing module 101. For example, when the user selects a function option of Game once at school at PM2:00, a field of the school corresponding to the Game function option as shown in FIG. 2 is increased by one, and a field of PM12:01˜PM4:00 corresponding to the Game function option as shown in FIG. 3 is increased by one as well. There are two ways for accomplishing the updating. One is that the input module 103 directly transmits a function option 104 corresponding to user's selection to the memory 105 to update the pieces of information. The other one is that the input module 103 transmits the function option 104 to the counting module 111 which records the selected time of each of function options and periodically transmits a record result 106 to the memory 105 to update the pieces of information.

Accordingly, when the user tries to select the function options of the mobile electronic apparatus 1 again, the processing module 107 can arrange a sequence of the function options according to the pieces of information, i.e., the selected time of each of the function options and the environment parameters 100 and 102 sensed by the sensing module 101. More times one of the function options is selected, the more preceding position in the sequence the function option locates. There are many ways for calculating the sequence. For example, the usage times of each function option in the table as shown in FIG. 2 and FIG. 3 can be considered together to obtain the sequence. Furthermore, other multi-variable algorithms can be used, such as Genetic Algorithm, Simulated Annealing Algorithm, Ant Algorithm, Neural Network, etc.

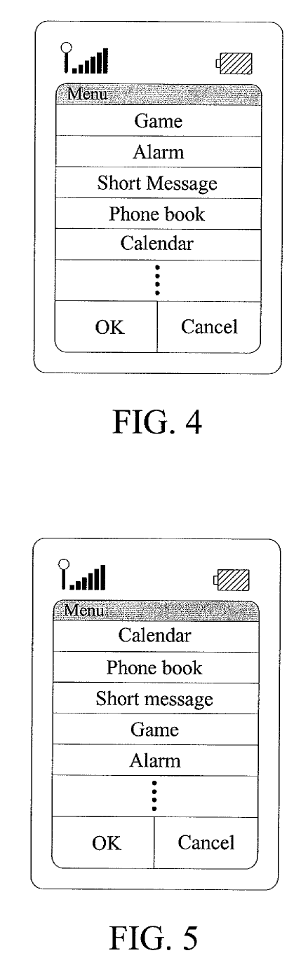

Finally, the processing module 107 generates a menu 108 by arranging the sequence of the usage times of the function options. Then, the menu 108 is transmitted to the display module 109 for display. The menu 108 is generated according to the sequence arranged by the processing module 107. For example, when the user uses the mobile electronic apparatus 1 at PM9:00 at home, the processing module 107 directly accumulates the times of the function option that the user selects in fields of home and ranging from PM08:01 to PM12:00. As shown in FIG. 2, the usage time of Short Message at home is 3, the usage time of Phone Book at home is 4, the usage time of Calendar at home is 4, the usage time of Alarm at home is 10, and the usage time of Game at home is 15. Furthermore, as shown in FIG. 3, the usage time of Short Message between PM08:01 to PM12:00 is 11, the usage time of Phone Book between PM08:01 to PM12:00 is 9, the usage time of Calendar between PM08:01 to PM12:00 is 8, the usage time of Alarm between PM08:01 to PM12:00 is 15, and the usage time of Game between PM08:01 to PM12:00 is 13. An accumulation result is as follows: 14 times for Short Message, 13 times for Phone Book, 12 times for Calendar, 25 times for Alarm, and 28 times for Game. The processing module 107 arranges the sequence of the function options according to the accumulation result. The sequence is: Game, Alarm, Short Message, Phone Book, and Calendar. As shown in FIG. 4, the display module 109 displays the menu 108.

If the user selects the function options at PM3:00 in the office, the processing module 107 directly accumulates the usage times between PM12:01 to PM04:00 in the office. As show in FIG. 2, the usage time of Short Message in the office is 2, the usage time of Phone Book in the office is 3, the usage time of Calendar in the office is 9, the usage time of Alarm in the office is 4, and the usage time of Game in the office is 2. Furthermore, as shown in FIG. 3, the usage time of Short Message between PM12:01 to PM04:00 is 9, the usage times of Phone Book between PM12:01 to PM04:00 is 11, the usage time of Calendar between PM12:01 to PM04:00 is 12, the usage time of Alarm between PM12:01 to PM04:00 is 2, and the usage time of Game between PM12:01 to PM04:00 is 6. An accumulation result is as follows: 11 times for Short Message, 14 times for Phone Book, 21 times for Calendar, 6 times for Alarm, and 8 times for Game. The processing module 107 arranges the sequence of the function options according to the accumulation result. The sequence is: Calendar, Phone Book, Short Message, Game, and Alarm. As shown in FIG. 5, the display module 109 displays the menu 108.

This invention does not limit the timing for the processing module 107 to arrange the sequence of the function options. The processing module 107 can arrange the sequence in real time or periodically, such as every two hours or every 4 hours. Those skilled in the art can accomplish the arrangement by using any time period.

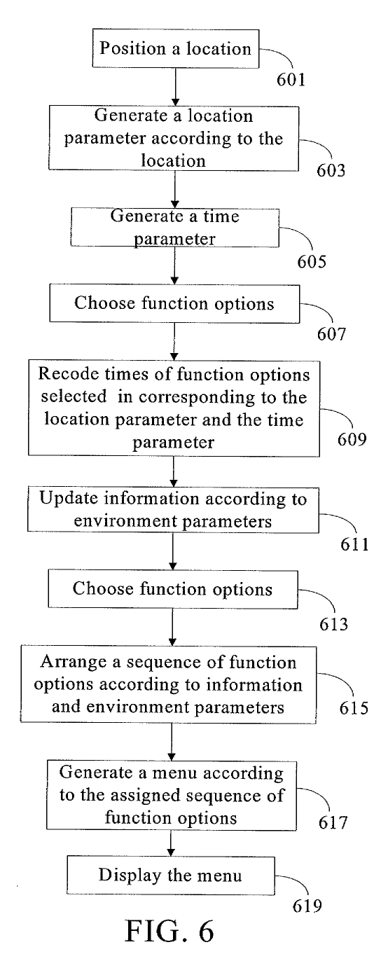

A second embodiment of the present invention is a method for dynamically arranging a display sequence of a plurality of function options. The method is applied to the mobile electronic apparatus 1 described in the first embodiment. As shown in FIG. 6, the method of the second embodiment is performed by a computer program which is stored in a computer readable medium.

At first, step 601 is executed in which the computer program comprises code for the positioning module 1011 positioning a location of the mobile electronic apparatus 1. Next, step 603 is executed in which the computer program comprises code for the positioning module 1011 generating a location parameter according to the location. Similarly, the positioning method can be performed by currently techniques of Global Positioning System, Global Navigation Satellite System, and Galileo Positioning System, etc. Step 605 is executed in which the computer program comprises code for the timing module 1013 generating a time parameter. In other words, the computer program comprises code for accomplishing the sensing of a plurality of environment parameters by step 601, step 603, and step 605. Next, step 607 is executed in which the input module 103 comprises code for a user selecting the function options available in the mobile electronic apparatus 1. Next, step 609 is executed in which the computer program comprises code for the memory 105 getting the location parameter and the time parameter via the processing module 107 to record the usage times of the function options selected by the user in corresponding to the location parameter and the time parameter. Step 611 is executed in which the computer program comprises code for the memory 105 updating a plurality of pieces of information regarding place and time according to the environment parameters sensed by the sensing module 101. Next, step 613 is executed in which the input module 103 comprises code for the user selecting the function options available in the mobile electronic apparatus 1. Next, step 615 is executed in which the computer program comprises code for the processing module 107 arranging the sequence of the function options according the pieces of information and the environment parameters sensed by the sensing module 101. Next, step 617 is executed in which the computer program comprises code for the processing module 107 generating a menu according to the sequence of the function options. Finally, step 619 is executed in which the computer program comprises code for the display module 109 displaying the menu.

In addition to the steps in FIG. 6, the computer program of the second embodiment has code able to execute of all the operations in the first embodiment. Those skilled in the art can straightforwardly realize how the second embodiment performs these operations and functions based on the above descriptions of the first embodiment, and thus no unnecessary detail is given.

A third embodiment of the present invention is another method for dynamically arranging a display sequence of plurality of function options. For a more detailed description, the method of the third embodiment is the same as the method of the second embodiment.

At first, step 601 is executed for positioning a location. Next, step 603 is executed for generating a location parameter according to the location. Step 605 is executed for generating a time parameter. In other words, the method accomplishes the sensing of a plurality of environment parameters by step 601, step 603 and step 605. Next, step 607 is executed for a uses selecting function options available in the mobile electronic apparatus. Next, step 609 is executed for recording the usage times of the function options selected by the user in corresponding to the location parameter and the time parameter. Step 611 is executed for updating a plurality of pieces of information regarding place and time according to the environment parameters. Next, step 613 is executed for the user selecting function options available in the mobile electronic apparatus. Next, step 615 is executed for arranging the sequence of the function options according to the pieces of information and the environment parameters. Next, step 617 is executed for generating a menu according to the sequence of the function options. Finally, step 619 is executed for displaying the menu.

In addition to the steps in FIG. 6, the method of the third embodiment is able to execute of all the operations in the first embodiment. Those skilled in the art can straightforwardly realize how the third embodiment performs these operations and functions based on the above descriptions of the first embodiment, and thus no unnecessary detail is given.

The computer program may be stored in a computer readable medium. The computer readable medium can be a floppy disk, a hard disk, a flash disk, a tape, a database accessible from a network, or any storage medium with the same functionality that can be easily thought by people skilled in the art.

Accordingly, the present invention utilizes carious of environment parameters and records selected times of the function options selected by the user to arrange a sequence and display the function options. When the user stays in different environments, the present invention can display the most frequently used function options of the environment at that time. Meanwhile, the present invention also records times of using the function options in different environment. With this method, the drawback of manually arranging the sequence of the function options or arranging the sequence only depending on the times that the user selects the function options of the prior art without considering an affection of environment factors can be solved successfully. Furthermore, it is able to make users selecting the most suitable and arranged function options rapidly at a corresponding time or a corresponding place. This invention will change the habits of users in using the mobile electronic apparatuses so that a usage of the mobile electronic apparatus enters an unprecedented condition. Users can easily use the mobile electronic apparatuses with this invention and will not face the awkward situation that cannot find the intended function options while required temporarily.

The above disclosure is related to the detailed technical contents and inventive features thereof. People skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A mobile electronic apparatus capable of dynamically arranging a display sequence of a plurality of function options, comprising:
a sensing module for sensing a plurality of environment parameters of the mobile electronic apparatus;
an input module for a user to select one of the function options;
a memory for storing a plurality of pieces of information, the pieces of information being updated dynamically according to the selection;
a processing module for arranging the display sequence according to the environment parameters and the pieces of information; and
a display module for displaying the function options in the display sequence.

2. The mobile electronic apparatus of claim 1, wherein the pieces of information are updated in the memory in real time when the user selects one of the function options via the input module.

3. The mobile electronic apparatus of claim 1, further comprising a counting module for respectively recording selected times of the function options, wherein the pieces of information are updated periodically according to the selected times.

4. The mobile electronic apparatus of claim 1, wherein one of the environment parameters is a location parameter, the sensing module comprises a positioning module for positioning a location of the mobile electronic apparatus and generating the location parameter according to the location, and the pieces of information are updated dynamically according to the location parameter.

5. The mobile electronic apparatus of claim 4, wherein the positioning module positions the location based on one of Global Positioning System (GPS), Global Navigation Satellite System (GLONASS), and Galileo Positioning System (GPS).

6. The mobile electronic apparatus of claim 1, wherein one of the environment parameters is a time parameter, the sensing module comprises a timing module for generating the time parameter, and the pieces of information are updated dynamically according to the time parameter.

7. The mobile electronic apparatus of claim 1, wherein the processing module arranges the display sequence periodically.

8. A method for dynamically arranging a display sequence of a plurality of function options, comprising the steps of:
storing a plurality of pieces of information;
sensing a plurality of environment parameters;
selecting one of the function options;
updating the pieces of information dynamically according to the selection of the selecting step;
arranging the display sequence according to the environment parameters and the pieces of information; and
displaying the function options in the display sequence.

9. The method of claim 8, wherein the pieces of information are updated in real time according to the selection of the selecting step.

10. The method of claim 8, further comprising the steps of:
recording selected times of the function options respectively;
wherein the pieces of information are updated periodically according to the selected times.

11. The method of claim 8, further comprising the steps of:
positioning a location; and
generating a location parameter according to the location;
wherein the pieces of information are updated dynamically according to the location parameter.

12. The method of claim 11, wherein the location is positioned based on one of Global Positioning System, Global Navigation Satellite System, and Galileo Positioning System.

13. The method of claim 8, further comprising the steps of:
generating a time parameter;
wherein the pieces of information are updated dynamically according to the time parameter.

14. The method of claim 8, wherein the arranging step is executed periodically.

15. A computer readable medium storing a computer program for a mobile electronic apparatus to execute a method for dynamically arranging a display sequence of a plurality of function options, the method comprising the steps of:
storing a plurality of pieces of information;
sensing a plurality of environment parameters;
selecting one of the function options;
updating the pieces of information dynamically according to the selection of the selecting step;
arranging the display sequence according to the environment parameters and the pieces of information; and
displaying the function options in the display sequence.

16. The computer readable medium of claim 15, wherein the pieces of information are updated in real time according to the selection of the selecting step.

17. The computer readable medium of claim 15, wherein the method further comprises the step of:
recording selected times of the function options respectively;
wherein the pieces of information are updated periodically according to the selected times.

18. The computer readable medium of claim 15, wherein the method further comprises the steps of:
positioning a location; and
generating a location parameter according to the location;
wherein the pieces of information are updated dynamically according to the location parameter.

19. The computer readable medium of claim 15, wherein the method further comprises the step of:
generating a time parameter;
wherein the pieces of information are updated dynamically according to the time parameter.

20. The computer readable medium of claim 15, wherein the arranging step is executed periodically.
